(19) United States
(12) Patent Application Publication
(10) Pub. No.: US 2001/0039323 A1
(43) Pub. Date: Nov. 8, 2001

(54) Addition-crosslinkable silicone compositions comprising low-molecular weight alkenyl-terminated polydiorganosiloxanes

(75) Inventors: Frank Achenbach, Simbach am Inn (DE); Christof Worner, Burghausen (DE)

Correspondence Address: William G. Conger, Brooks & Kushman P.C., 22nd Floor, 1000 Town Center, Southfield, MI, 48075-1351, US

(73) Assignee: Wacker-Chemie GmbH, Munchen (DE)

(21) Appl. No.: 09/813,631

(22) Filed: Mar. 21, 2001

(30) Foreign Application Priority Data
Apr. 6, 2000 (DE) 100 17 154.0

(51) Int. Cl. C08G 77/06

(52) U.S. Cl. 528/15

(57) ABSTRACT

The invention relates to addition-crosslinkable silicone compositions which comprise:

(A) diorganopolysiloxane(s) with a viscosity of from 10 to 40,000 Pa•s determined at 25° C., composed of two units of the general formula (1)

[R₂R¹SiO_{1/2}] (1),

units of the general formula (2)

[R₂SiO_{2/2}] (2), and

from 0 to 0.3 % by weight of units of the general formula (3)

[RR¹SiO_{2/2}] (3),

(B) from 0.05 to 25% by weight, based on the sum of the weights of diorganopolysiloxane (A) and diorganopolysiloxane(s) (B), of diorganopolysiloxane(s) with a viscosity of from 60 to 2 000 mPa•s, determined at 25° C., composed of 2 units of the general formula (1), and units of the general formula (2),

(C) an SiH-functional crosslinker, and

(D) a hydrosilylation catalyst, wherein

R is an optionally substituted hydrocarbon group and R¹ is an unsaturated, optionally substituted hydrocarbon group.

### BACKGROUND OF THE INVENTION

1. Field of the Invention

The invention relates to addition-crosslinkable silicone compositions and to the silicone elastomers obtainable therefrom.

2. Background Art

It is known that addition of low-viscosity alkenyl-functionalized polydiorganosiloxanes to high-viscosity alkenyldiorganosiloxy-terminated polydiorganosiloxanes improves the physical properties of the silicone elastomers prepared from these polymer mixtures via addition-crosslinking, particularly tear propagation resistance. One method used for improving the mechanical properties, of high viscosity alkenyldiorganosiloxy terminated polydiorganosiloxanes, in particular the tear propagation resistance, is to add polydiorganosiloxanes having both terminal and pendant alkenyl groups, or low-viscosity alkenyldiorganosiloxy-terminated polydiorganosiloxanes having a viscosity below 50 mPa•s.

EP-A-856 561 describes a polyorganosiloxane formulation in which a low-viscosity polydiorganosiloxane which bears both terminal and pendant vinyl groups is employed, and which provides silicone elastomers with improved mechanical properties. Optionally, a vinyl-terminated polyorganosiloxane with a viscosity less than 20,000 mPa•s may be employed in amounts of up to 30 % by weight. According to EP-A-695 787, the tear propagation resistance of a silicone elastomer can be improved with the aid of a low-molecular-weight vinyl-terminated polydiorganosiloxane with a viscosity of from 1.0 to less than 50 mPa•s. However, the tear propagation resistances of both such silicone elastomers remain unsatisfactory.

U.S. Pat. No. 3,884,866 describes improvements in the mechanical properties of silicone elastomers by adding 5-40% of a 50-5,000 mPa•s viscosity polymer mixture composed of various vinyl-containing polydiorganosiloxanes, to a relatively high-viscosity vinyl-terminated polydiorganosiloxane. The vinyl groups of the low viscosity vinyl-containing polydiorganosiloxanes may be either within the chain or at the end of the chain. In all of the examples listed, the low-viscosity polymer mixture comprises a mixture of α,w-divinyl-terminated and monovinyl-terminated polydiorganosiloxanes. Although the tear propagation resistance is very high, other mechanical properties are poor. In particular, the compression set is too high.

It would be desirable to provide addition-crosslinkable silicone compositions which can be crosslinked to give silicone elastomers with very high tear propagation resistances, but also with low compression sets.

### SUMMARY OF THE INVENTION

It has now been discovered that the physical properties of additional cross-linked organopolysiloxane elastomers may be increased while maintaining low compression set, through the use of a particular class of α,w-alkenyl-terminated siloxanes having a viscosity between 60 mPa•s and 2000 mPa•s.

### DETAILED DESCRIPTION OF THE PREFERRED EMBODIMENT(S)

The invention provides addition-crosslinkable silicone compositions which comprise:

A) diorganopolysiloxane(s) with a viscosity of from 10 to 40,000 Pa•s determined at 25° C., comprised of two units of the general formula (1)

[R₂R¹SiO_{1/2}] (1),

units of the general formula (2)

[R₂SiO_{2/2}] (2),

and from 0 to 0.3% by weight of units of the general formula (3)

[RR¹SiO_{2/2}] (3),

where in the general formulae (1) to (3)

R are identical or different monovalent, optionally halogen- or cyano-substituted, SiC-bonded C₁-C₁₈-hydrocarbon radicals free from carbon-carbon aliphatic multiple bonds, and

R¹ are identical or different monovalent, optionally halogen- or cyano-substituted, C₁-C₁₀-alkenyl groups, optionally bonded to silicon via a bivalent organic group;

(B) from 0.05 to 25% by weight, based on the sum of the weights of diorganopolysiloxane(s) (A) and diorganopolysiloxane(s) (B), of diorganopolysiloxane(s) with a viscosity of from 60 to 2,000 mPa•s, determined at 25° C., composed of 2 units of the general formula (1), and units of the general formula (2);

(C) SiH-functional crosslinker(s) whose average general formula is (4)

HₐR²_{b}SiO_{(4-a-b)/2} (4),

where

R² is as defined for R, and a and b are non-negative integers, with the proviso that 0.5<(a +b)<3.0, and 0<a <2, and that at least two silicon-bonded hydrogen atoms are present in each molecule; and

(D) a hydrosilylation catalyst.

Examples of unsubstituted hydrocarbon radicals R are alkyl radicals such as methyl, ethyl, n-propyl, isopropyl, n-butyl, isobutyl, tert-butyl, n-pentyl, isopentyl, neopentyl, and tert-pentyl, hexyl radicals such as n-hexyl, heptyl radicals such as n-heptyl, octyl radicals, such as n-octyl, and isooctyl radicals, such as 2,2,4-trimethylpentyl radical, nonyl radicals such as n-nonyl, decyl radicals such as n-decyl, dodecyl radicals such as n-dodecyl, octadecyl radicals such as n-octadecyl; cycloalkyl radicals such as cyclopentyl radicals, cyclohexyl radicals, 4-ethylcyclohexyl radicals, cycloheptyl radicals, norbornyl radicals, and methylcyclohexyl radicals; aryl radicals, such as phenyl, biphenylyl, naphthyl, anthryl, and phenanthryl; alkaryl radicals, such as o-, m-, and p-tolyl radicals, xylyl radicals, and ethylphenyl radicals; aralkyl radicals, such as benzyl, alpha and β-phenylethyl, and also fluorenyl.

Examples of substituted hydrocarbon radicals R are halogenated hydrocarbons, such as chloromethyl, 3-chloropropyl, 3-bromopropyl, 3,3,3-trifluoropropyl, and 5,5,5,4,4,3,3-heptafluoropentyl, and also chlorophenyl, dichlorophenyl, and trifluorotolyl.

The hydrocarbon radical R is preferably unsubstituted or substituted C₁-C₆ alkyl or phenyl, in particular methyl or phenyl.

The alkenyl groups R¹ are available for an addition reaction with the SiH functional crosslinker (B). Use is usually made of alkenyl groups having from 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl or allyl.

Non-limiting examples of divalent organic groups via which the alkenyl groups R¹ may be bonded to silicon of the polymer chain are those composed of oxyalkylene units, for example those of the general formula (5)

—(O)ₘ[(CH₂)ₙO]ₒ— (5),

where

m is 0 or 1, in particular 0,

n is from 1 to 4, in particular 1 or 2, and

o is from 1 to 20, in particular from 1 to 5.

The oxyalkylene units of the general formula (5) have bonding on the left-hand side to a silicon atom.

The diorganopolysiloxane (A) preferably has a viscosity of from 15 to 35,000 Pa•s, determined at 25° C. The diorganopolysiloxane (A) preferably has from 0 to 0.1% by weight of units of the general formula (3), and in particular no such units.

The diorganopolysiloxane (B) preferably has a viscosity of from 60 to 500 mPa•s, in particular up to 300 mPa•s, determined at 25° C. The amount of diorganopolysiloxane (B) present is preferably from a minimum of 0.1% by weight to a maximum of 15% by weight, in particular not more than 10% by weight, based on the entirety of diorganopolysiloxane (A) and diorganopolysiloxane (B). The low viscosity unsaturated component contains substantially no organopolysiloxanes having but a single aliphatically unsaturated hydrocarbon groups, i.e. less than 10 mol percent based on total low viscosity unsaturated organopolysiloxane component. Preferably, the low viscosity unsaturated component, and thus also the overall crosslinkable composition contain no low viscosity mono-unsaturated organopolysiloxanes.

It is preferable to use a crosslinker (C) containing three or more SiH bonds per molecule. If use is made of a crosslinker which has only two SiH bonds per molecule, it is advisable to use a diorganopolysiloxane (A) which has at least three alkenyl groups per molecule. The hydrogen content of the crosslinker (C) is based exclusively on the hydrogen atoms directly bonded to silicon atoms and is preferably in the range from 0.002 to 1.7% by weight of hydrogen, with preference from 0.1 to 1.7% by weight of hydrogen.

The crosslinker (C) preferably contains at least three and not more than 600 silicon atoms per molecule. It is preferable to use a crosslinker (C) which contains from 4 to 200 silicon atoms per molecule. The structure of the crosslinker (C) may be linear, branched, cyclic or of the nature of a network.

Particularly preferred crosslinkers (C) are linear polyorganosiloxanes of the general formula (6)

(HR³₂SiO_{1/2})_{c}(R³₃SiO_{1/2})_{d}(HR³SiO_{2/2})ₑ(R³₂SiO_{2/2})_{f} (6),

where

R³ are as defined for R, and the non-negative integers c, d, e and f comply with the following relationships: (c+d)=2, (c+e)>2, 5<(e+f)<200 and 1>e/(e+f)>0.1.

The amount of the SiH-functional crosslinker (C) present in the crosslinkable silicone rubber composition is preferably such that the molar ratio of SiH groups to alkenyl groups is from 0.5 to 5, in particular from 1.0 to 3.0.

The hydrosilylation catalyst (D) used may be any of the known catalysts which catalyze the hydrosilylation reactions taking place during the crosslinking of addition-crosslinking silicone compositions. Particular hydrosilylation catalysts (D) which may be used are metals and their compounds, for example platinum, rhodium, palladium, ruthenium, and iridium, preferably platinum. The use of platinum and platinum compounds is preferred. It is particularly preferable to use platinum compounds which are soluble in polyorganosiloxanes. Examples of soluble platinum compounds which may be used are the platinum-olefin complexes of the formulae (PtCl₂•olefin)₂ and H(PtCl₃•olefin), where use is preferably made of alkenes having from 2 to 8 carbon atoms, such as ethylene, propylene, butene isomers or octene isomers, or of cycloalkenes having from 5 to 7 carbon atoms, for example cyclopentene, cyclohexene, or cycloheptene. Other soluble platinum catalysts are the platinum-cyclopropane complex of the formula (PtCl₂C₃H₆)₂, the reaction products of hexachloroplatinic acid with alcohols, with ethers, and with aldehydes, or with mixtures of these, and the reaction product of hexachloroplatinic acid with methylvinylcyclotetrasiloxane in the presence of sodium bicarbonate in ethanolic solution. Particular preference is given to complexes of platinum with vinylsiloxanes, for example sym-divinyltetramethyldisiloxane.

The hydrosilylation catalyst (D) may be used in any desired form, and may, for example, be used in the form of hydrosilylation catalyst present within microcapsules or within organopolysiloxane particles. The selected content of hydrosilylation catalysts (D) is such that the Pt content of the addition-crosslinkable silicone composition is from 0.1 to 100 ppm (parts per million), preferably from 0.5 to 40 ppm.

The vulcanized silicone rubber has greater mechanical strength if the addition-crosslinkable silicone compositions further comprise fillers which give active reinforcement as constituent (E). Preferred fillers (E) which give active reinforcement are precipitated or fumed silicas, or mixtures of these. The specific surface area of these actively reinforcing fillers should be at least 50 m²/g, preferably within the range from 100 to 400 m²/g, as determined by the BET method. Fillers of this type which give active reinforcement are very well known materials in the field of silicone rubbers. The content of actively reinforcing filler (E) in the addition-crosslinkable silicone compositions is preferably in the range from 5 to 60% by weight, in particular from 10 to 40% by weight.

If desired, the addition-crosslinkable silicone compositions may comprise other additives as constituents (F) in a proportion of up to 70 % by weight, preferably from 0.01 to 40% by weight. Examples of these additives are nonreinforcing fillers, dispersing agents, coupling agents, inhibitors, pigments, dyes, plasticizers, catalysts, silicones, heat stabilizers, etc.

The addition-crosslinkable silicone compositions are compounded by mixing the components listed above in any desired sequence. The crosslinking of the addition-crosslinkable silicone compositions preferably takes place by heating, preferably at from 30 to 250° C., minimal cure temperatures are preferably at least 50° C., more preferably at least 100° C., yet more preferably at least 200° C., and in particular at least 180° C.

Silicone elastomers which are obtainable by crosslinking the addition-crosslinkable silicone compositions described heretofore are also part of the invention herein.

In the examples below, unless otherwise stated, all pressures are 0. 10 MPa (abs.), and all temperatures are 20° C.

### EXAMPLES:

### Example 1

### Preparation of starting composition

200 parts by weight of a vinyldimethylsiloxy-terminated polydimethylsiloxane with a viscosity of 20,000 mPa•s (25° C.) in a laboratory kneader are heated to 150° C. and mixed with 164 parts by weight of a hydrophobic fumed silica with a BET specific surface area of 300 m²/g and a carbon content of 3.9% by weight. This gave a highly viscous composition which was then diluted with 211 parts by weight of the abovementioned polydimethylsiloxane and 11.7 parts by weight of a vinyldimethylsiloxy-terminated polydimethylsiloxane with a viscosity of 100 mPa•s (25° C.). Volatile constituents were removed by kneading in vacuo (10 mbar) at 150° C. for an hour.

550 g of this starting composition were mixed on a roll mill at a temperature of 25° C., with 0.40 g of ethynylcyclohexanol, 12.7 g of a copolymer composed of dimethylsiloxy units, methylhydrosiloxy units and trimethylsiloxy units, with a viscosity of 300 mPa•s at 25° C. and an SiH content of 0.48 %, and 0.48 g of a solution comprising a platinum-sym-divinyltetramethyldisiloxane complex comprising 1 % by weight of Pt. The resulting Pt content of the silicone composition was 9 ppm.

The silicone compositions prepared in this way were then crosslinked in a hydraulic press at a temperature of 170° C. over a period of 10 minutes. Following demolding, silicone elastomer sheets, having thicknesses of about 2 mm and 6 mm, were annealed for 6 hours at 200° C. in a circulating-air drying cabinet.

### Example 2

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 150 mPa•s (25° C.). Other aspects of the mixing procedure for the silicone composition remained unchanged, as did the further processing.

### Example 3

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 200 mPa•s (25° C.). Other aspects of the mixing procedure for the silicone composition remained unchanged, as did the further processing.

### Example 4

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 84 mPa•s (25° C.). Other aspects of the mixing procedure for the silicone composition remained unchanged, as did the further processing.

### Example 5

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 61 mPa•s (25° C.). Other aspects of the mixing procedure for the silicone composition remained unchanged, as did the further processing.

### ComParative Example C1

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 39 mPa•s (25° C.). Other aspects of the mixing procedure for the silicone composition remained unchanged, as did the further processing.

### ComParative Example C2

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 23 mPa•s (25° C.). Other aspects of the mixing procedure for the silicone composition remained unchanged, as did the further processing.

### ComParative Example C3

The procedure of Example 1 was followed, but instead of the vinyl-dimethylsiloxy-terminated polydimethylsiloxane with a viscosity of 100 mPa•s (25° C.) used in Example 1, use was made of a vinyldimethylsiloxy-terminated polydimethylsiloxane with a viscosity of 20,000 mPa•s (25° C.). Other aspects of the mixing procedure for the silicone composition remained unchanged, as did the further processing.

TABLE 1
Effect of viscosity of added low-molecular-weight vinyldimethylsiloxy-terminated polydimethylsiloxane on mechanical
properties of LSR elastomers. The values for post-cured silicone elastomers are given in parentheses.

| | Viscosity of low-molecular- | | Tear | | | |
|---|---|---|---|---|---|---|
| | weight vinyldimethylsiloxy- | | resistance | | | Elongation at |
| | terminated polydimethylsiloxane | Hardness | (ASTM D624) | Compression set | Tensile strength | break |
| | [mPa · s] | [Shore A] | [N/mm] | [%] | [N/mm²] | [%] |
| Comparative | not present | 43 (44) | 22 (26) | 62 (10) | 8.9 (8.7) | 584 (524) |
| Example C3 | | | | | | |
| Comparative | 23 | 46 (46) | 27 (32) | 66 (10) | 7.8 (8.0) | 536 (465) |
| Example C2 | | | | | | |
| Comparative | 39 | 47 (47) | 34 (32) | 66 (9) | 8.6 (7.6) | 549 (429) |
| Example C1 | | | | | | |
| Example 5 | 61 | 46 (46) | 36 (36) | 63 (8) | 8.5 (8.1) | 547 (474) |
| Example 4 | 84 | 47 (46) | 36 (37) | 59 (8) | 8.2 (8.1) | 532 (468) |
| Example 1 | 100 | 47 (46) | 45 (39) | 63 (8) | 8.8 (8.2) | 530 (444) |
| Example 2 | 150 | 45 (45) | 44 (35) | 63 (9) | 8.4 (8.1) | 536 (472) |
| Example 3 | 200 | 45 (46) | 40 (36) | 71 (10) | 8.8 (8.2) | 568 (456) |

It can be seen from Table 1 that the use of low-molecular-weight vinyldimethylsiloxy-terminated polydimethylsiloxane with a viscosity of 60-200 mPa•s (25° C.) gives the highest tear propagation resistances as measured in accordance with ASTM D624.

### Example 6

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 0.1% by weight of vinyldimethylsiloxy-terminated polydimethylsiloxane with a viscosity of 100 mPa•s (25° C.). Other aspects of the mixing procedure of the silicone composition remained unchanged, as did the further processing.

### Example 7

The procedure Example 1 was followed, but instead of the proportion of 2.0 % by weight of vinyldimethylsiloxy-terminated polydimethylsiloxane with a viscosity of 100 mPa•s (25° C.) used in the starting composition in Example 1, use is made of 0.5 % by weight of vinyldimethylsiloxy-terminated polydimethylsiloxane with a viscosity of 100 mPa•s (25° C.). Other aspects of the mixing procedure of the silicone composition remained unchanged, as did the further processing.

### Example 8

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 1.0% by weight of vinyldimethylsiloxy-terminated polydimethylsiloxane with a viscosity of 100 mPa•s (25° C.). Other aspects of the mixing procedure of the silicone composition remain unchanged, as did the further processing.

### Example 9

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 5.0% by weight of vinyldimethylsiloxy-terminated polydimethylsiloxane with a viscosity of 100 mPa•s (25° C.). Other aspects of the mixing procedure of the silicone composition remain unchanged, as did the further processing.

### Example 10

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 10.0% by weight of vinyldimethylsiloxy-terminated polydimethylsiloxane with a viscosity of 100 mPa•s (25° C.). Other aspects of the mixing procedure of the silicone composition remain unchanged, as did the further processing.

TABLE 2
Effect of proportion of vinyldimethylsiloxy-terminated polydimethylsiloxane with a viscosity of 100 mPa · s on the
mechanical properties of LSR elastomers. The values for post cured silicone elastomers are given in parentheses

| | Proportion by weight of low- | | | | | |
|---|---|---|---|---|---|---|
| | molecular-weight vinyldimethyl- | | | | | |
| | siloxy-terminated polydimethyl- | | Tear | | | |
| | siloxane (100 mPa · s at 25° C.) in | | resistance | | | Elongation at |
| | starting composition | Hardness | (ASTM D624) | Compression set | Tensile strength | break |
| | [% by weight] | [Shore A] | [N/mm] | [%] | [N/mm²] | [%] |
| Example 6 | 0.1 | 45 (46) | 25 (28) | 60 (10) | 8.6 (8.3) | 580 (480) |
| Example 7 | 0.5 | 45 (45) | 33 (38) | 59 (11) | 8.1 (8.3) | 549 (474) |
| Example 8 | 1.0 | 46 (46) | 34 (36) | 60 (12) | 8.7 (8.6) | 585 (465) |
| Example 1 | 2.0 | 47 (46) | 45 (39) | 58 (9) | 8.8 (8.4) | 567 (454) |
| Example 9 | 5.0 | 47 (48) | 42 (35) | 60 (12) | 8.3 (8.8) | 542 (442) |
| Example 10 | 10.0 | 44 (50) | 39 (36) | 62 (12) | 7.3 (7.6) | 506 (354) |

It can be seen from Table 2 that the use of 2% by weight of low-molecular-weight vinyldimethylsiloxy-terminated polydimethylsiloxane with a viscosity of 100 mPa•s (25° C.) gives the highest tear propagation resistances.

### Example 11

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 2.0% by weight of vinyldimethylsiloxy-terminated polydimethylsiloxane with a viscosity of 310 mPa•s (25° C.). Other aspects of the mixing procedure of the silicone composition remained unchanged, as did the further processing.

### ComParative Example C4

The procedure of Example 1 was followed, but instead of the proportion of 2.0% by weight of vinyldimethylsiloxy-terminated polydimethylsiloxane with a viscosity of 100 mPa•s (25° C.) used in the starting composition in Example 1, use is made of 1.3% by weight of vinyldimethylsiloxy-terminated polydimethylsiloxane with a viscosity of 310 mPa•s (25° C.), and 0.7 % by weight of monovinyldimethylsiloxy-monotrimethylsiloxy-terminated polydimethylsiloxane with a viscosity of 320 mPa•s (25° C.). Other aspects of the mixing procedure of the silicone composition remained unchanged, as did the further processing.

### ComParative Example C5

The procedure of Example 1 was followed, but instead of the proportion of 2.0% by weight of vinyldimethylsiloxy-terminated polydimethylsiloxane with a viscosity of 100 mPa•s(25° C.) used in the starting composition in Example 1, use is made of 1.0 % by weight of vinyldimethylsiloxy-terminated polydimethylsiloxane with a viscosity of 310 mPa•s (25° C.), and 1.0 % by weight of monovinyldimethylsiloxy-monotrimethylsiloxy-terminated polydimethylsiloxane with a viscosity of 320 mPa•s (25° C.). Other aspects of the mixing procedure of the silicone composition remained unchanged, as did the further processing.

TABLE 3
Effect of end group (vinyldimethylsiloxy or trimethylsiloxy) of low-molecular-weight polydimethylsiloxane on the
mechanical properties of LSR elastomers. The values for post cured silicone elastomers are given in parentheses.

| | Proportion by weight of low-molecular- | | | | | | |
|---|---|---|---|---|---|---|---|
| | weight polydimethylsiloxane in starting | | | | | | |
| | composition | | | | | | |
| | [% by weight] | | | | | | |
| | Bilaterally vinyl- | | | | | | |
| | dimethylsiloxy- | Monovinyldimethyl- | | Tear | | | |
| | terminated | siloxy-monotrimethyl- | | resistance (ASTM | Compression | Tensile | Elongation at |
| | (310 mPa · s at | siloxy-terminated | Hardness | D624) | set | strength | break |
| | 25° C.) | (310 mPa · s at 25° C.) | [Shore A] | [N/mm] | [%] | [N/mm²] | [%] |
| Example 11 | 2.0 | — | 45 (45) | 39 (36) | 67 (10) | 8.9 (8.7) | 550 (498) |
| Example C4 | 1.3 | 0.7 | 45 (45) | 36 (35) | 70 (13) | 8.8 (8.8) | 555 (480) |
| Example C5 | 1.0 | 1.0 | 45 (45) | 37 (35) | 73 (16) | 8.6 (8.5) | 556 (510) |

It can be seen from Table 3 that when the vinyldimethylsiloxy end group is replaced to some extent by the trimethylsiloxy end group in the low-molecular-weight polydimethylsiloxane, the compression set of the silicone elastomers prepared from the starting compositions is increased.

### Example 12

411 parts by weight of a vinyldimethylsiloxy-terminated polydimethylsiloxane having a Brabender plasticity of 630 mkp at 25° C. were mixed with 164 parts by weight of a hydrophobic fumed silica with a BET surface area of 300 m²/g and a carbon content of 3.9% by weight, added in portions, by means of a sigma-type kneader at 70° C. over a period of one hour, to yield a homogeneous starting composition. This composition was kneaded and heated for 3 hours at 150° C. under the vacuum generated by an oil pump. The mixture was then diluted with 11.7 parts by weight of a vinyldimethylsiloxy-terminated polydimethylsiloxane with a viscosity of 100 mPa•s (25° C.).

550 g of this starting composition were mixed on a roll mill at a temperature of 25° C., with 0.66 g of ethynylcyclohexanol, 11.0 g of a copolymer composed of dimethylsiloxy units, methylhydrosiloxy units and trimethylsiloxy units, having a viscosity of 300 mPa•s at 25° C. and an SiH content of 0.48 %, and 0.48 g of a solution comprising a platinum-sym-divinyltetramethyldisiloxane complex comprising 1 % by weight of Pt. The overall Pt content of the silicone composition was 9 ppm.

The silicone compositions prepared in this way were then crosslinked in a hydraulic press at a temperature of 170° C. over a period of 10 minutes. Following demolding, silicone elastomer sheets having thicknesses of about 2 mm and 6 mm were annealed for 6 hours at 200° C. in a circulating-air drying cabinet.

### ComParative Example C6

The procedure of Example 12 was followed, but instead of the vinyl-dimethylsiloxy-terminated polydimethylsiloxane with a viscosity of 100 mPa•s (25° C.) used in Example 12, use was made of a vinyldimethylsiloxy-terminated polydimethylsiloxane with a Brabender plasticity of 630 mkp (25° C.). Other aspects of the mixing procedure for the silicone composition remained unchanged, as did the further processing.

TABLE 4
Effect of low-molecular-weight vinyldimethylsiloxy-terminated polydimethylsiloxane with a viscosity of 100 mPa · s
(25° C.) on the mechanical properties of HTV elastomers. The values for post cured silicone elastomers are given
in parentheses.

| | Proportion by weight of low- | | | | | |
|---|---|---|---|---|---|---|
| | molecular-weight vinyldimethyl- | | | | | |
| | siloxy-terminated polydimethyl- | | Tear | | | |
| | siloxane (100 mPa · s at 25° C.) in | | resistance (DIN | Compression | | Elongation at |
| | starting composition | Hardness | 53507) | set | Tensile strength | break |
| | [% by weight] | [Shore A] | [N/mm] | [%] | [N/mm²] | [%] |
| Comparative | — | 35 (38) | 12.0 (12.9) | 58 (16) | 11.5 (11.8) | 1173 (1064) |
| Example C6 | | | | | | |
| Example 12 | 2.0 | 38 (40) | 13.7 (13.4) | 55 (15) | 12.9 (11.7) | 1184 (1066) |

It can be seen from table 4 that addition of low-molecular-weight vinyldimethylsiloxy-terminated polydimethylsiloxane with a viscosity of 100 mPa•s (25° C.) increases the tear propagation resistance to DIN 53507.

### Example 13

411 parts by weight of a vinyldimethylsiloxy-terminated polydimethylsiloxane having a Brabender plasticity of 630 mkp and an average of 3 vinylmethylsiloxy groups per chain, were mixed at 25° C. with 164 parts by weight of a hydrophobic fumed silica with a BET surface area of 300 m²/g and a carbon content of 3.9% by weight, added in portions over a period of one hour, in a sigma-type kneader at 70° C. to yield a homogeneous starting composition. This composition was kneaded and heated for 3 hours at 150° C. under the vacuum generated by an oil pump. The mixture was then diluted with 11.7 parts by weight of a vinyldimethylsiloxy-terminated polydimethylsiloxane with a viscosity of 100 mPa•s (25° C.).

550 g of this starting composition were mixed on a roll mill at a temperature of 25° C., with 0.66 g of ethynylcyclohexanol, 11.0 g of a copolymer composed of dimethylsiloxy units, methylhydrosiloxy units and trimethylsiloxy units, having a viscosity of 300 mPa•s at 25° C. and an SiH content of 0.48 %, and 0.48 g of a solution comprising a platinum-sym-divinyltetramethyldisiloxane complex comprising 1% by weight of Pt. The overall Pt content of the silicone composition was 9 ppm.

The silicone compositions prepared in this way were then crosslinked in a hydraulic press at a temperature of 170° C. over a period of 10 minutes. Following demolding, silicone elastomer sheets having thicknesses of about 2 mm and 6 mm were annealed for 6 hours at 200° C. in a circulating-air drying cabinet.

### ComParative Example C7

The procedure of Example 13 was followed, but instead of the vinyl-dimethylsiloxy-terminated polydimethylsiloxane having a viscosity of 100 mPa•s (25° C.) used in Example 13, a vinyldimethylsiloxy-terminated polydimethylsiloxane with a Brabender plasticity of 630 mkp (25° C.) and an average of 3 vinylmethylsiloxy groups/chain was employed. Other aspects of the mixing procedure for the silicone composition remained unchanged, as did the further processing.

TABLE 5
Effect of low-molecular-weight vinyldimethylsiloxy-terminated polydimethylsiloxane with a viscosity of 100 mPa · s
(25° C.) on the mechanical properties of HTV elastomers. The values for post cured silicone elastomers are given
in parentheses.

| | Proportion by weight of low- | | | | | |
|---|---|---|---|---|---|---|
| | molecular-weight vinyldimethyl- | | Tear | | | |
| | siloxy-terminated polydimethyl- | | propagation | | | |
| | siloxane (100 mPa · s at 25° C.) in | | resistance DIN | Compression | | Elongation at |
| | starting composition | Hardness | 53507 | set | Tensile strength | break |
| | [% by weight] | [Shore A] | [N/mm] | [%] | [N/mm²] | [%] |
| Comparative | — | 39 (43) | 14.2 (14.9) | 65 (19) | 11.3 (10.8) | 1090 (872) |
| Example C7 | | | | | | |
| Example 13 | 2.0 | 42 (45) | 17.3 (18.4) | 63 (20) | 11.6 (11.3) | 1074 (930) |

It can be seen from Table 5 that the addition of low-molecular-weight vinyldimethylsiloxy-terminated polydimethylsiloxane with a viscosity of 100 mPa•s (25° C.) also improves the tear propagation resistance to DIN 53507 of vinylmethylsiloxy-containing vinyldimethylsiloxy-terminated HTV polymers.

In the Examples, the standards used for silicone elastomer properties were DIN 53505 (Shore A), DIN 53504-S1 (tear strength and elongation at break), ASTM D624B and, respectively, DIN 53507 (tear propagation resistance), and DIN 53517 (compression set).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. The terms “a” and “an” in the claims herein mean “one or more” unless clearly indicated to the contrary.

What is claimed is:

1. An addition-crosslinkable silicone composition which comprises:
(A) at least one diorganopolysiloxane with a viscosity of from 10 to 40,000 Pa•s determined at 25° C., comprising two units of the general formula (1)
[R₂R¹SiO_{1/2}] (1),
units of the general formula (2)
[R₂SiO_{2/2}] (2), and
from 0 to 0.3% by weight of units of the general formula (3)
[RR¹SiO_{2/2}] (3),
where in the general formulae (1) to (3)
R are identical or different monovalent, optionally halogen- or cyano-substituted, SiC-bonded C₁-C₁₈-hydrocarbon radicals free from carbon-carbon aliphatic multiple bonds, and
R¹ are identical or different monovalent, optionally halogen- or cyano-substituted, C₁-C₁₀-alkenyl groups, bonded directly to silicon, or optionally bonded to silicon via a bivalent organic group,
(B) from 0.05 to 25% by weight, based on the sum of the weights of diorganopolysiloxane(s) (A) and diorganopolysiloxane(s) (B), of a low viscosity aliphatically unsaturated organopolysiloxane component consisting essentially of diorganopolysiloxane with a viscosity of from 60 to 2,000 mPa•s, determined at 25° C., containing 2 units of the general formula (1), and units of the general formula (2),
(C) SiH-functional crosslinker(s) whose average general formula is (4)
HₐR²_{b}SiO(_{4-a-b)/}₂ (4),
where
R² is as defined for R, and a and b are non-negative integers,
with the proviso that 0.5<(a +b)<3.0, and 0<a<2, and that at least two silicon-bonded hydrogen atoms are present, on average, in each molecule, and
(D) at least one hydrosilylation catalyst.

2. The addition-crosslinkable silicone composition as claimed in claim 1, in which constituent (A) has a viscosity of from 15 to 35,000 Pa•s, determined at 25° C.

3. The addition-crosslinkable silicone composition as claimed in claim 1, in which the diorganopolysiloxane (A) has from 0 to 0.1% by weight of units of the general formula (3).

4. The addition-crosslinkable silicone composition as claimed in claim 2, in which the diorganopolysiloxane (A) has from 0 to 0.1% by weight of units of the general formula (3).

5. The addition-crosslinkable silicone composition as claimed in claim 1, in which the diorganopolysiloxane (B) has a viscosity of from 60 to 500 mPa•s, determined at 25° C.

6. The addition-crosslinkable silicone composition as claimed in claim 2, in which the diorganopolysiloxane (B) has a viscosity of from 60 to 500 mPa•s, determined at 25° C.

7. The addition-crosslinkable silicone composition as claimed in claim 3, in which the diorganopolysiloxane (B) has a viscosity of from 60 to 500 mPa•s, determined at 25° C.

8. The addition-crosslinkable silicone composition as claimed in claim 4, in which the diorganopolysiloxane (B) has a viscosity of from 60 to 500 mPa•s, determined at 25° C.

9. The addition-crosslinkable silicone composition of claim 1, in which the amount of the diorganopolysiloxane (B) present is from 0.1 to 15 % by weight, based on the sum of the weights of diorganopolysiloxane (A) and diorganopolysiloxane (B).

10. The addition-crosslinkable silicone composition of claim 2, in which the amount of the diorganopolysiloxane (B) present is from 0.1 to 15 % by weight, based on the sum of the weights of diorganopolysiloxane (A) and diorganopolysiloxane (B).

11. The addition-crosslinkable silicone composition of claim 3, in which the amount of the diorganopolysiloxane (B) present is from 0.1 to 15 % by weight, based on the sum of the weights of diorganopolysiloxane (A) and diorganopolysiloxane (B).

12. The addition-crosslinkable silicone composition of claim 5, in which the amount of the diorganopolysiloxane (B) present is from 0.1 to 15 % by weight, based on the sum of the weights of diorganopolysiloxane (A) and diorganopolysiloxane (B).

13. The addition-crosslinkable silicone composition of claim 1, in which the amount of the diorganopolysiloxane (B) present is from 0.1 to 10 % by weight, based on the sum of the weights of diorganopolysiloxane (A) and diorganopolysiloxane (B).

14. The addition-crosslinkable silicone composition of claim 5, in which the amount of the diorganopolysiloxane (B) present is from 1.0 to 5.0 % by weight, based on the sum of the weights of diorganopolysiloxane (A) and diorganopolysiloxane (B).

15. The addition-crosslinkable silicone composition of claim 5, in which the amount of the diorganopolysiloxane (B) present is from about 2 % by weight, based on the sum of the weights of diorganopolysiloxane (A) and diorganopolysiloxane (B).

16. The additional crosslinkable silicone composition of claim 1, further comprising a hydrophobic reinforcing filler and optionally a non-functional organopolysiloxane.

17. A silicone elastomer obtainable by crosslinking the addition-crosslinkable silicone composition as claimed in claim 1.
